(19) United States
(12) Patent Application Publication
(10) Pub. No.: US 2004/0153569 A1
(43) Pub. Date: Aug. 5, 2004

(54) Samaritan circuit for transferring data through peer-to-peer networks

(76) Inventor: Khamla Savathphoune, Chicago, IL (US)

Correspondence Address: KHAMLA SAVATHPHOUNE, 3660 N. LAKESHORE #503, CHICAGO, IL, 60613, US

(21) Appl. No.: 10/356,874

(22) Filed: Feb. 3, 2003

(51) Int. Cl. G06F 15/173; G06F 15/177

(52) U.S. Cl. 709/238; 709/221

(57) ABSTRACT

The samaritan circuit is used to protect the identity of peers involved with the transfer of data in a peer-to-peer network. Instead of making direct connections during transfers, each peer connects through the samaritain circuit. The chain is composed of dynamically created peers.

### FEDERALLY SPONSORED RESEARCH

Not Applicable

### SEQUENCE LISTING OR PROGRAM

Not Applicable

### BACKGROUND OF INVENTION

Current peer-to-peer systems do not have the ability to anonymously transfer data among themselves without the need for a central entity. For instance in a typical transaction, when peer A needs to transfer data to peer B, peer A directly opens a connection to peer B. For this transaction, both peers must know each other's IP address. The receiver peer and the sender peer each directly communicates with each other.

Since both the receiver and the sender peer can determine the identities of each other, the peer-to-peer environment can be monitored and censored. This can lead to having information which maybe offensive to certain groups but beneficial to society censored and made unavailable.

Anonymous transfer of data among peers can be accomplished by using central entities. For example, mixers can be used to redirect data. Onion networks can be established. However, there are many disadvantages to using central entities to keep the identities of both the sender and receiver confidential. For instance, central entities can be targeted and rendered useless by denial of service attacks. Central entities can be manipulated by their owners to reveal the identities of both the sender and the receiver.

### BRIEF SUMMARY OF THE INVENTION

This invention called the samaritan circuit provides a virtual circuit which is dynamically created by the use of other peers in a peer-to-peer network. This virtual circuit does not rely on having central entities which have the main responsibility in redirecting the data or obscuring the identities of the sender and the receiver. Instead, it dynamically uses peers as proxies for both the receiver and the sender to create anonymous and confidential transfer of data. Because of this, it is more secure than other methods. Also, it is less vulnerable to attacks because it has no central entity. In addition, with the use of encryption, like public and private key, the data can be encrypted in order that eavesdroppers and the peer proxies may not know what the data represents when it is transferred.

### DRAWINGS

FIG. 1 is a representation of a peer-to-peer network.

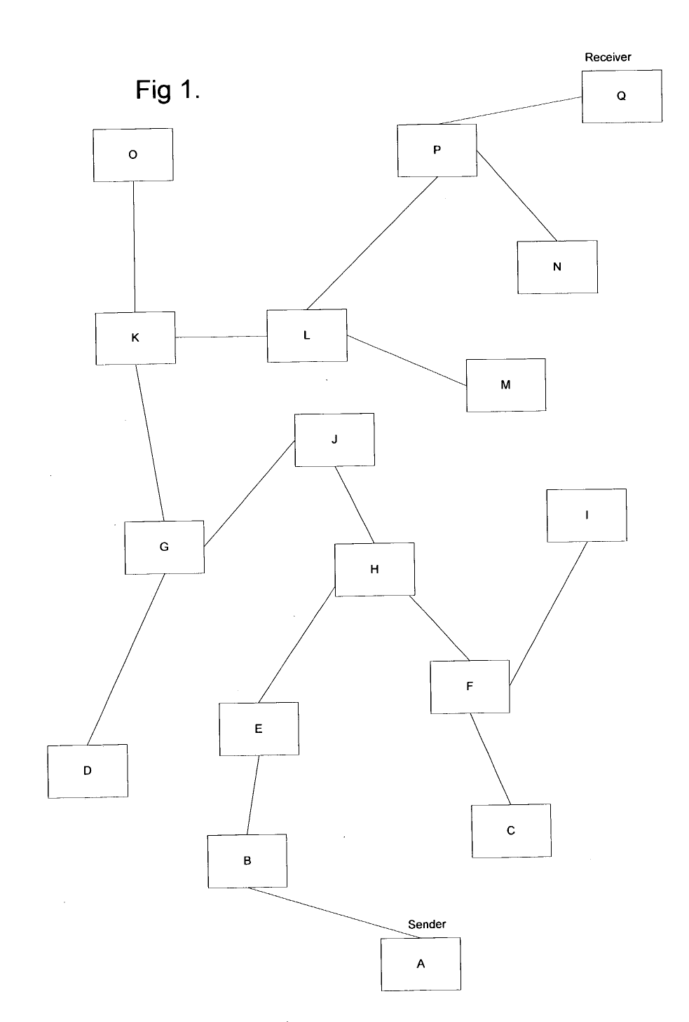

FIG. 2 is a representation of a virtual circuit of the present invention consisting of the peers A, C, E, H, J, M, N, and Q.

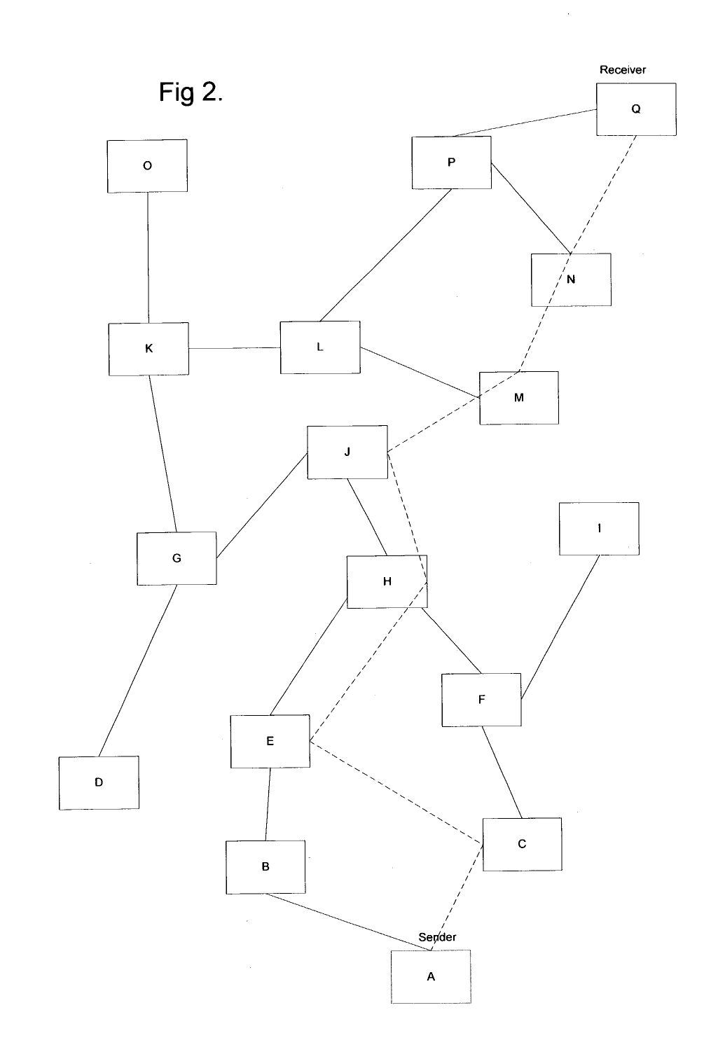

### DETAILED DESCRIPTION OF THE INVENTION

A preferred embodiment of the present invention involves the use of a computer program that acts as a peer in a peer to peer network. In addition to being executed on a computer, the program can be executed on a wireless device like a cell phone or a personal digital assistant. Also, it can be developed in any programming language. In this embodiment, the programming language is Java and it is located on a computer.

Each peer which is represented by a program on a computer which participates on a peer to peer network. A typical example of this type of network is the Gnutella network. However, unlike the Gnutella network and other peer-to-peer networks, there will not be any direct connection between the receiver and sender during transfer of data. For example, when a peer wants to download or upload a file. Instead of a direct connection, a virtual circuit will be used. This virtual circuit will obscure the identity of both the sender and the receiver from eavesdroppers and from the sender and the receiver themselves. The present invention, hence, eliminates the previous drawback of data transfer in peer-to-peer networks where both the receiver and the sender are known to each other.

The present invention is a virtual circuit incorporating these peers. One peer will act as a sender and the other will act as a receiver. The sender has the data that the receiver wishes to obtain. The virtual circuit starts with either the sender or the receiver creating a chain of peers that will act as proxies. In this embodiment, the chain is first created by the receiver who sends messages on the peer-to-peer network requesting for peers that will be able to act like proxies. Once a peer is selected from those available on the network, the sender connects to it via sockets. It will then form the ending of the chain. The ending of the chain will then request from the network other peers that will act as a proxy for the peer which is currently acting as the ending of the chain when a peer is found, it will connect to the chain and it will then take over the role as the ending of the chain. In this manner, this series of proxy peers will continue to grow for a number of minutes in order for there to be a sufficient number of proxies. Even if there are only one or two proxies in this chain, each individual proxy will no longer be able to deduce who the true identity of the receiver is since they are only able to identify the peers whom they are individually connected with. They will not able to see the entire chain.

When the chain stops growing, the current end of the chain will then send information related to the ip address and port number to the receiver via the chain. This information maybe encrypted. By using the chain to pass this information, the identity of the receiver is protected. The ip and port number can than be used by any peer. When a peer wishes to send data to the receiver, it will connect to the end of the chain.

The chain created by the sender is developed using the same method. However, when the chain is formed, the ending of the chain does not send information regarding available IP and port to the receiver peer. Instead, when a sender wishes to send data, the sender peer sends the ip and port number of the peer whom has the data through the chain. This information maybe encrypted. Ultimately, the peer at the end of the chain uses this information to connect to the peer at the end of the chain that the receiver has created. The transfer of data is then conducted through this main chain which is the combination of the receiver chain and the sender chain that obscures both the sender and receiver. With the use of data encryption, the data can also be hidden from ease droppers.

What is claimed is:

1) A virtual circuit that is a pathway between two peer devices, one defined as a receiver and the other defined as a sender and both communicating with each other through a peer to peer network, which said circuit comprising of a main, dynamic chain of peer devices acting like proxy servers that is dynamically created and dynamically attached by means to said receiver and said sender.

2) The virtual circuit of claim 1 wherein said main chain of peers is comprised of peers with the ability by means to associate with the chain or disassociate from the chain.

3) The virtual circuit of claim 2 wherein the chain is made up of smaller, minor chains, originating from said receiver and originating for said sender.

4) The virtual circuit of claim 3 wherein the minor chain originating from the receiver has as a beginning, said receiver which has means to query available peers to associate with said receiver.

5) The virtual circuit of claim 4 wherein said peer has the ability to independently and iteratively connect to other peers wherein compromising said minor chain originating from the receiver.

6) The virtual circuit of claim 5 wherein the minor chain originating from the sender has as a beginning of the chain, the sender which has means to query available peers to associate with said sender and the ability of said peers to iterative add other available peers similar to minor chain originating from the sender.

7) The virtual circuit of claim 6 wherein said minor chain originating from the sender has the means to connect to said minor chain originating from the receiver forming said virtual circuit.
